(19) United States
(12) Patent Application Publication
(10) Pub. No.: US 2019/0098570 A1
(43) Pub. Date: Mar. 28, 2019

(54) Methods and Apparatus for Measurement and Connectivity Control in Macro-Assisted Heterogeneous Network

(71) Applicant: MediaTek Singapore Pte. Ltd., Singapore (SG)

(72) Inventors: Yuanyuan Zhang, (US); I-Kang Fu, Taipei City (TW); Aimin Justin Sang, San Diego, CA (US)

(21) Appl. No.: 16/166,354

(22) Filed: Oct. 22, 2018

Related U.S. Application Data
(63) Continuation of application No. PCT/CN2016/080030, filed on Apr. 22, 2016.

(51) Int. Cl. H04W 48/20; H04W 28/02

(52) U.S. Cl. CPC H04W 48/20; H04W 84/045; H04W 28/0268

(57) ABSTRACT

Methods and apparatus are provided for UE-centric measurement and connectivity control in macro-assisted heterogeneous network. In one novel aspect, the UE establishes a connection with a macro base station in a heterogeneous wireless network. The UE collects and analyzes UE status information locally. Subsequently, the UE autonomously initiates access to a small cell base station if access criteria are met based on the locally collected UE status information. In one embodiment, the UE informs the macro base station and the one or more small-cell base stations of the small-cell base station. In another embodiment, the UE starts a supervise timer before initiating access the one or more small-cell base stations and autonomously initiates a subsequent accessing procedure to another small cell base station upon detecting an access failure until the supervising timer expires. The UE stops the access procedure upon the supervise timer expires.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2016/080030, with an international filing date of Apr. 22, 2016. This application is a continuation of International Application No. PCT/CN2016/080030. International Application No. PCT/CN2016/080030 is pending as of the filing date of this application, and the United States is a designated state in International Application No. PCT/CN2016/080030. The disclosure of each of the foregoing documents is incorporated herein by reference.

### TECHNICAL FIELD

The disclosed embodiments relate generally to wireless communication, and, more particularly, to methods and apparatus for measurement and connectivity control in network of multiple RAT, especially the macro-assisted heterogeneous network.

### BACKGROUND

Heterogeneous network is one of the most important deployment for the next generation wireless network. With the user equipment (UE) supporting multiple radio access, the flexibility and addition bandwidth offered by the heterogeneous network (HeNet) has become increasing popular. In the traditional network, the control of network connection and small cell connectivity are controlled by the base station or network. The UE needs to receive control signals to initiate access or establish connectivity to a new cell. With the integration of new-developed technology into the HeNet, such centralized design becomes less efficient and less flexible with longer latency due to the complex procedures between the UE and the network, and sometimes cannot keep with the extremely high requirements targeted in 5G. For example, the millimeter wave (mmW) network requires relatively much faster access to the new base station than the existing radio access considering the mmW specific characteristics, such as venerability to the radio environment, high blockage probability and high power consumption for measurement. With network-centric method of mmW small cell connectivity control, the channel quality of the target mmW small cell may become out-of-dated or even unavailable after the cumbersome steps and signaling.

The available spectrum of the mmW band is two hundred times greater than the conventional cellular system. The mmW wireless network uses directional communications with narrow beams and can support multi-gigabit data rate. The underutilized bandwidth of the mmW spectrum has wavelengths ranging from 1 mm to 100 mm. The very small wavelengths of the mmW spectrum enable a large number of miniaturized antennas to be placed in a small area. Such miniaturized antenna system can produce high beamforming gains through electrically steerable arrays generating directional transmissions.

With recent advances in mmW semiconductor circuitry, mmW wireless system has become a promising solution for the real implementation. However, the heavy reliance on directional transmissions and the vulnerability of the propagation environment present particular challenges for the mmW network. For example, mmW channel changes much faster than today's cellular system due to the small coherence time, which is about hundreds of microsecond. The mmW communication depends extensively on adaptive beamforming at a scale that far exceeds current cellular system. Further, the high reliance on the directional transmission introduces new issues for synchronization. Broadcast signals may delay the base station detection during cell search for initial connection setup and for handover because both the base station and the mobile station need to scan over a range of angles before the mobile station can detect the base station. Furthermore, mmW signals are extremely susceptible to shadowing. The appearance of obstacles, such as human bodies and outdoor materials would cause the signal outage. The small coverage of the cell causes the relative path loss and the cell association to change rapidly. Resolving frequent intermittent connectivity loss and enabling rapid adaptable communication is one of the key features of the development of the mmW wireless network.

In today's HeNet, the measurement and connection control are network centric. Such architecture creates longer latency from UE sending the measurement report of the small cells to the macro cell to the UE can successfully communicate with the small cells. Upon accessing the small cell, the RRC connection Reconfiguration procedure needs to be done. The UE uses Random Access (RA) with the small cell base stations. Such network centric procedure introduces long latency in network connectivity for the UE. Further, in small cell systems such as the mmW, the adding and removing the mmW base station and handovers occur very frequently due to blockage. The existing network centric connectivity management with long latency may cause connection interruption and other problems for the HeNet. One significant problem is power consumption for small cell measurement. In current network implementation, the network according to the deployment scenarios always configures measurement objects for the purpose of small cell management. Therefore, UE always performs the measurement for potential utilization of the small cell even there is no services of large amount of data requiring high data rate is ongoing or upcoming. It consumes UE's battery unnecessarily sometimes.

Improvements and enhancements are required for measurement and connectivity control in macro-assisted HeNet to reduce latency and power consumption.

### SUMMARY

Methods and apparatus are provided for UE-centric measurement and connectivity control in macro-assisted heterogeneous network. In one novel aspect, the UE establishes a connection, e.g. control plane connection with a macro base station in a heterogeneous wireless network, wherein the connection controller controls one or more connectivity with one or more small-cell base stations, in one case, the above connection could be called control plane connection to the person skilled in the art. The UE collects and analyzes UE status information locally. Subsequently, the UE autonomously initiates access to a small cell base station if one or more access criteria are met based on the locally collected UE status information. In one embodiment, the macro base station is a cellular base station and the one or more small-cell base stations are millimeter wave (mmW) base stations. The access criteria are based on triggering conditions comprising at least one of the following: a required data traffic rate is higher than a data-traffic rate threshold, an amount of traffic volume is higher than a traffic volume threshold, a UE mobility speed is lower than a speed threshold, and the UE is in a proximity of one or more small cell cells. In one embodiment, the access criteria are detecting all the triggering conditions. In another embodiment, the triggering conditions are prioritized, and wherein the access criteria are met when one or more high priority triggering conditions are met. In yet another embodiment, the traffic QoS requirements have the highest priority when considering the different triggering events. In one embodiment, the UE informs the one or more small-cell base stations about the information relevant to the macro base station and receives acknowledgement for service transportation from the one or more small-cell base stations. UE may also inform the macro base station about the status information relevant to the one or more small-cell base stations. In another embodiment, the UE starts a supervise timer upon initiating access the one or more small-cell base stations, and reports a timeout upon expiration of the supervising timer. The UE autonomously initiates a subsequent accessing procedure to another small cell base station upon detecting an access failure until the supervising timer expires.

### BRIEF DESCRIPTION OF THE DRAWINGS

The accompanying drawings, where like numerals indicate like components, illustrate embodiments of the invention.

FIG. 1 illustrates an exemplary HeNet network in accordance with embodiments of the current invention.

FIG. 2 is a schematic system diagram illustrating an exemplary wireless network with mmW connections in accordance with embodiments of the current invention.

FIG. 3 illustrates an exemplary top-level flow chart of an UE-centric measurement and connectivity control in accordance with embodiments of the current invention.

FIG. 4A illustrates an exemplary flow chart where the UE determines the criteria are met if all conditions are met in accordance with embodiments of the current invention.

FIG. 4B illustrates an exemplary flow chart where the UE determines the criteria are met if enough high priority conditions are met in accordance with embodiments of the current invention.

FIG. 5A illustrates an exemplary flow chart where the UE determines the criteria are met if all conditions are met with examples in accordance with embodiments of the current invention.

FIG. 5B illustrates an exemplary flow chart where the UE determines the criteria are met if enough high priority conditions are met with examples in accordance with embodiments of the current invention.

FIG. 6 illustrates an exemplary flow chart of connectivity initiation procedure by the UE in accordance with embodiments of the current invention.

FIG. 7 illustrates exemplary flow charts of connectivity control for the UE and the small-cell base station in accordance with embodiments of the current invention.

FIG. 8 illustrates an exemplary diagram of the autonomous UE-centric measurement and connectivity control procedures in accordance with embodiments of the current invention.

FIG. 9 illustrates an exemplary flow chart of using a supervise timer for the autonomous UE-centric connectivity control procedure in accordance with embodiments of the current invention.

FIG. 10 illustrates an exemplary flow chart of the UE autonomous measurement and connectivity control procedures in the heterogeneous network in accordance with embodiments of the current invention.

### DETAILED DESCRIPTION

Reference will now be made in detail to some embodiments of the invention, examples of which are illustrated in the accompanying drawings.

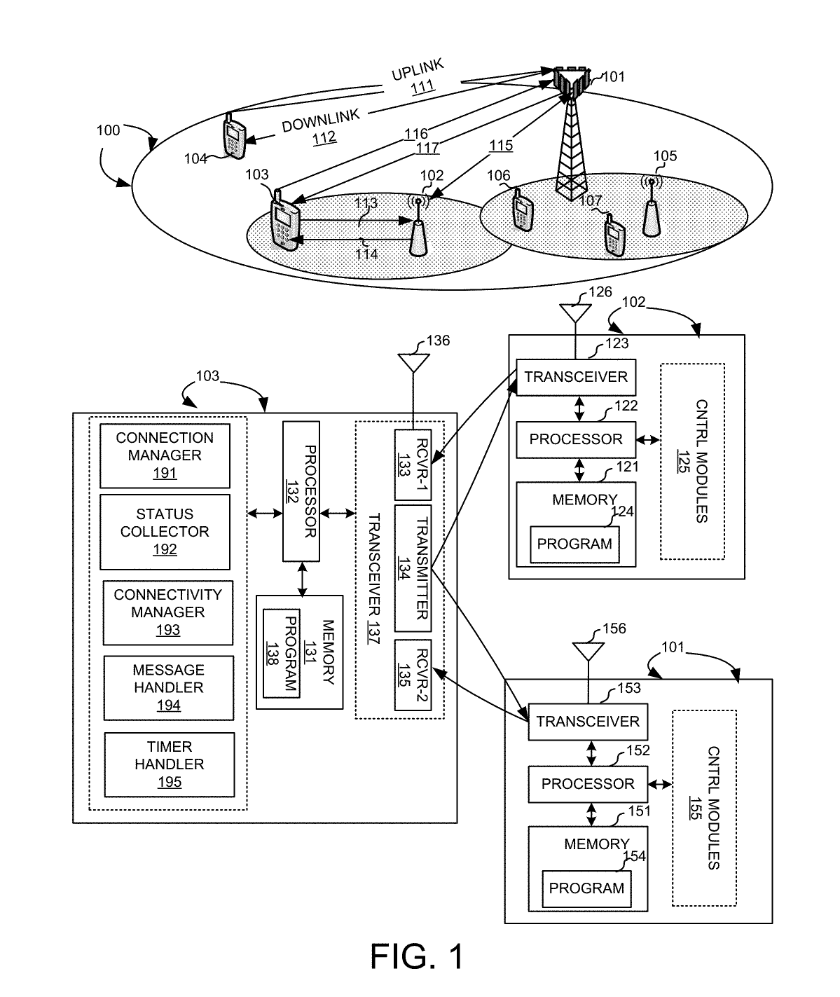

FIG. 1 illustrates an exemplary HeNet network 100 in accordance with embodiments of the current invention. Wireless communication system 100 includes one or more fixed base infrastructure units, such as base stations 101 102, and 105, forming a network distributed over a geographical region. The base unit may also be referred to as an access point, an access terminal, a base station, a Node-B, an eNode-B, an RRU/RRH or by other terminology used in the art. The one or more base units 101, 102 and 105 serve a number of mobile stations 103, 104, 106 and 107 within a serving area, for example, a cell, or within a cell sector. In particularly, base unit 101 operates as a macro-cell base station. Base unit 102 and 105 operate as small cells with same or different radio access technology. In one example, two base units 101 and 102 simultaneously serve the mobile station 103 within their common coverage. A back haul connection 115 connecting the non-co-located base stations 101 and 102 can be either ideal or non-ideal. Or a front haul connection connects the non-co-located RRU/RRH to the BBU pool.

Serving base units 101 and 102 transmit downlink communication signals 112, 114, and 116 to mobile stations in the time and/or frequency domain. Mobile station 103 and 104 communicate with one or more base units 101 and 102 via uplink communication signals 111, 113 and 117. In one embodiment, mobile communication network 100 is an wireless system comprising a base stations eNB 101, mmW base stations 102 and 105, and a plurality of mobile station 103, 104, 106, and 107. When mobile stations, such as mobile station 106, move in the wireless network, it keeps its connection to the macro-cell base station, such as base station 101. In one novel aspect, while having the connection with macro base station 101, a UE, such as UE 106, may autonomously choose to establish connectivity with different small cell base stations, such as base station 102 and 105 for data traffic transportation, wherein the transportation comprises the data transmission and the data reception. UE 106 autonomously initiates access to small cell 102 after connection is established with macro-cell base station 101. When UE 106 autonomously connecting to small-cell base stations, such 102 and 105, it is not triggered by any signaling from the network, but triggered by the local UE status information, which is monitored and analyzed by UE itself UE 106. It then autonomously initiates the access to the small-cell base station for additional connectivity for data transportation. The latency is reduced because UE can initiate the access procedure directly without waiting for the control signaling from the network. Therefore, the UE can react faster.

FIG. 1 further shows simplified block diagrams of base stations 101, 102 and mobile station 103 in accordance with the current invention. Base station 101 has an antenna 156, which transmits and receives radio signals. A RF transceiver module 153, coupled with the antenna, receives RF signals from antenna 156, converts them to baseband signals and sends them to processor 152. RF transceiver 153 also converts received baseband signals from processor 152, converts them to RF signals, and sends out to antenna 156. Processor 152 processes the received baseband signals and invokes different functional modules to perform features in base station 101. Memory 151 stores program instructions and data 154 to control the operations of base station 101. Base station 101 also includes a set of control modules 155 that carry out functional tasks to communicate with mobile stations.

Similarly, base station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules 125 that carry out functional tasks to communicate with mobile stations.

Mobile station 103 has an antenna 136, which transmits and receives radio signals. A RF transceiver module 137, coupled with the antenna, receives RF signals from antenna 136, converts them to baseband signals and sends them to processor 132. RF transceiver 137 also converts received baseband signals from processor 132, converts them to RF signals, and sends out to antenna 136. Processor 132 processes the received baseband signals and invokes different functional modules to perform features in mobile station 103. Memory 131 stores program instructions and data 138 to control the operations of mobile station 103. Transceiver 137 of mobile station 103 includes more receivers, for example two receivers 133 and 135 and one transmitter 134. Receiver 135 receives downlink transmissions from transceiver 153 of base station 101. Receiver 135 receives downlink transmissions from transceiver 123 of base station 102. On the uplink side, there is only one transmitter for mobile station 103, transmitter 134. Transmitter 134 transmits uplink signals to both base stations 101 and 102.

Mobile station 103 also includes a set of control modules that carry out functional tasks. A connection manager 191 establishes a control plane connection with a macro base station in a heterogeneous wireless network, wherein the control plane connection controls one or more connectivity with one or more small-cell base stations. A status collector 192 collects and analyzes UE status information locally. A connectivity manager 193 autonomously initiates access to a small cell base station after the establishment of the control plane connection if one or more access criteria are met based on the locally collected UE status information. A message handler 194 informs the one or more small-cell base stations about the information relevant to the macro base station, and receives acknowledgement for service transportation from the one or more small-cell base stations. It may also informs the macro base station of the status information relevant to the one or more small-cell base stations A timer handler 195 starts a supervising timer upon initiating accessing the one or more small-cell base stations, and reports a timeout upon expiration of the supervising timer.

In one novel aspect, the UE-centric measurement and connectivity control is used. The UE collects and analyzes its own UE status information locally. The UE initiates measurement procedure upon determining that one or more certain criteria are met. Subsequently, the UE initiates access to a small cell base station if the measurement results indicate one or more suitable small cell base stations. The HeNet system using the mmW technology benefits from the UE-centric measurement and connectivity control due to its specific characters.

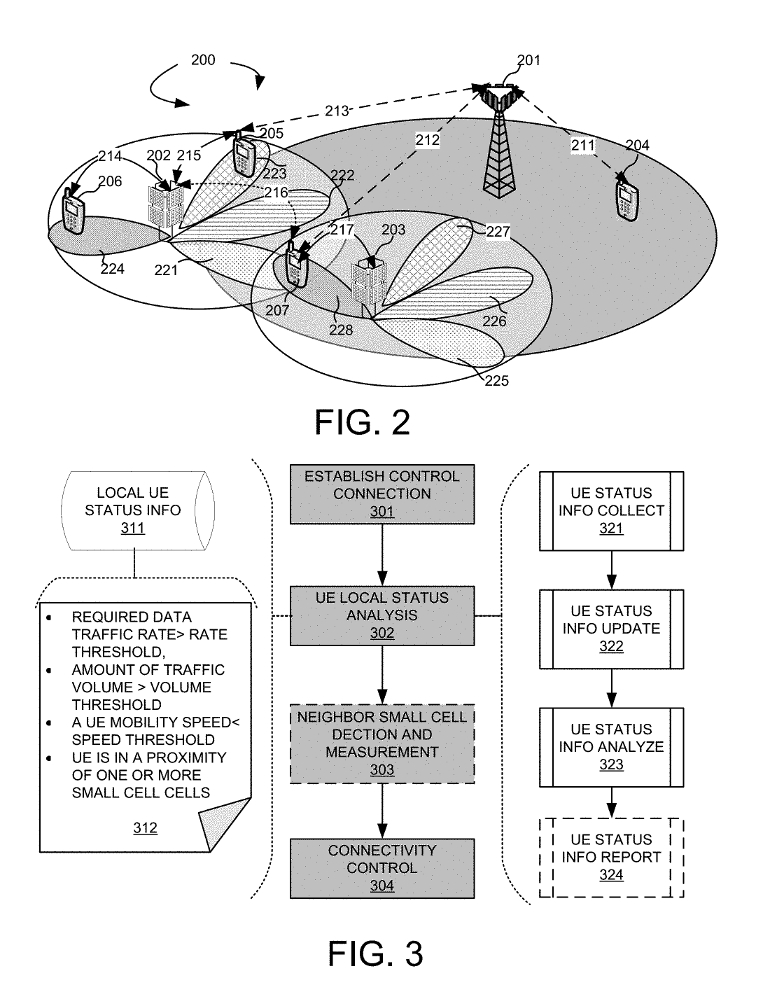

FIG. 2 is a schematic system diagram illustrating an exemplary wireless network 200 with mmW connections in accordance with embodiments of the current invention. Wireless system 200 includes one or more fixed base infrastructure units forming a network distributed over a geographical region. The base unit may also be referred to as an access point, an access terminal, a base station, a Node-B, an eNode-B, or by other terminology used in the art. As an example, base stations 201, 202 and 203 serve a number of mobile stations 204, 205, 206 and 207 within a serving area, for example, a cell, or within a cell sector. In some systems, one or more base stations are coupled to a controller forming an access network that is coupled to one or more core networks. In one case, eNB 201 is a conventional base station served as a macro eNB. eNB 202 and eNB 203 are mmW base station, the serving area of which may overlap with serving area of eNB 201, as well as may overlap with each other at the edge. If the serving area of mmW eNB does not overlap the serving area of macro eNB, the mmW eNB is considered as standalone, which can also provide service to users without the assistance of macro eNB. mmW eNB 202 and mmW eNB 203 has multiple sectors each with multiple control beams to cover a directional area. Control beams 221, 222, 223 and 224 are exemplary control beams of eNB 202. Control beams 225, 226, 227 and 228 are exemplary control beams of eNB 203. As an example, UE or mobile station 204 is only in the service area of eNB 101 and connected with eNB 201 via a link 211. UE 206 is connected with mmW network only, which is covered by control beam 224 of eNB 202 and is connected with eNB 202 via a link 214. UE 205 is in the overlapping service area of eNB 201 and eNB 202. In one embodiment, UE 205 is configured with multiple connectivity and can be connected with eNB 201 via a link 213 and eNB 202 via a link 215 simultaneously. UE 207 is in the service areas of eNB 201, eNB 202, and eNB 203. In embodiment, UE 207 is configured with multiple connectivity and can be connected with eNB 201 with a link 212 and eNB 203 with a link 217. In embodiment, UE 207 can switch to a link 216 connecting to eNB 202 upon connection failure with eNB 203. In this embodiment, UE 207 is configured with multiple connectivity and can be connected with eNB 201 with a link 212, eNB 203 with a link 217 and eNB 202 with a link 216.

FIG. 3 illustrates an exemplary top-level flow chart of an UE-centric measurement and connectivity control in accordance with embodiments of the current invention. At step 301, the UE establishes connection with a macro-cell base station. The control plane connection manages connections and the connectivity with each small-cell base stations. In one novel aspect, once the connection is established, the UE autonomously initiate measurement and access without signaling from the macro base station. At step 302, the UE locally collects and analyzes the UE status information. In one embodiment, the UE collects the UE status information locally and checks whether certain criteria are met based on the UE status information. At step 303, optionally, the UE performs neighbor small cell detection and measurement. The measurement is initiated if one or more certain criteria are met. The neighboring cell measurement is initiated and, optionally, the measurement reports are sent. At step 304, the UE performs connectivity control. The UE initiates small cell access autonomously. Subsequently, the UE receives acknowledgement from the small cell base station for service transportation.

In performing status analysis, the UE collects UE status information 311 locally. The UE status information includes traffic quality of service (QoS) requirements, UE mobility status, position information and UE channel status, e.g. CQI and RSRP/RSRQ etc. A set of criteria 312 is set. The criteria include at least one of the following ones: a required data traffic rate is higher than a data-traffic rate threshold, an amount of traffic volume is higher than a traffic volume threshold, a UE mobility speed is lower than a speed threshold, and the UE is in a proximity of one or more small cell cells. The UE can obtain the data-traffic rate using the on-going traffic detected or predict the upcoming traffic rate based on historic data. In one embodiment, the data-traffic criterion is met if the data-traffic volume is above a threshold or the required data rate for an application is above a threshold. In one embodiment, the UE mobility status criterion is met if the moving speed is below a threshold the small cell can support. In one embodiment, the UE determines the proximity to one or more small cells based on the footprint and/or the historic position information. The threshold for the data-traffic rate, the data volume, and the speed can be predefined or pre-configured by the network. These threshold values can also be determined and dynamically updated by the UE.

FIG. 3 also illustrates an exemplary flow chart of the UE locally collects and analyzes the UE status. At step 321, the UE locally collects UE status information. The UE status information includes service or traffic type with its corresponding QoS requirement, the UE mobility status, the UE position information, and the channel quality information of the serving cell. At step 322, the UE updates the UE status information. At step 323, the UE analyzes the UE status information. Optionally, at step 324, the UE sends the UE status information to the network.

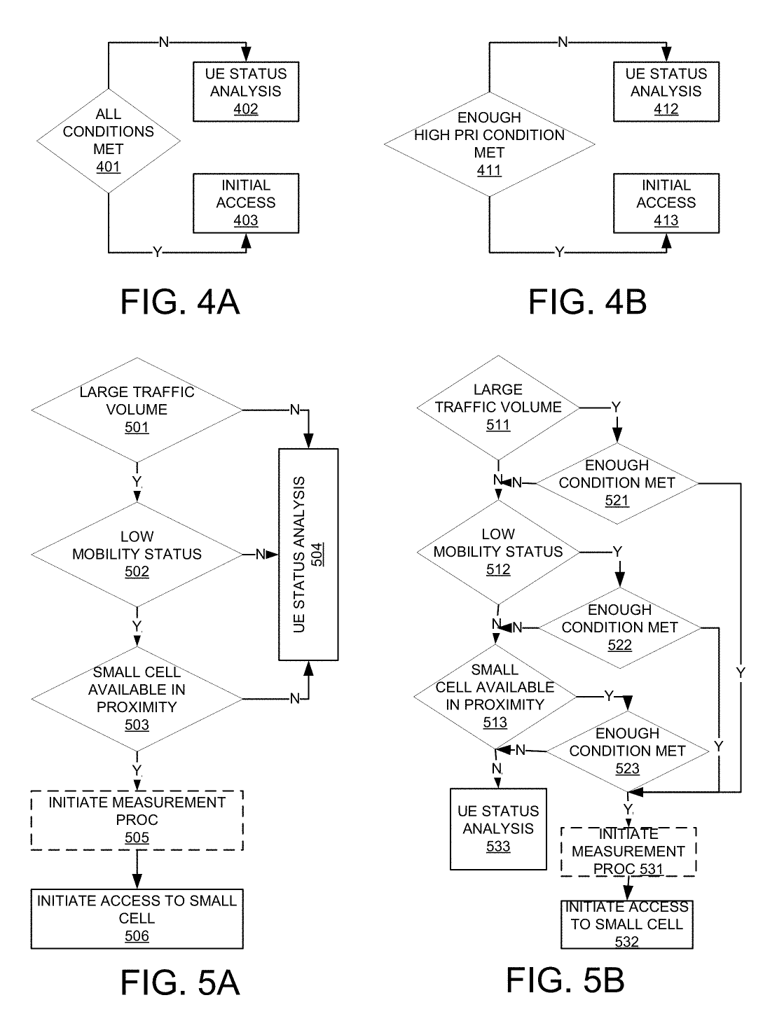

FIG. 4A illustrates an exemplary flow chart where the UE determines that the criteria are met if all conditions are met in accordance with embodiments of the current invention. At step 401, the UE determines if the conditions are met. The conditions can be predefined or preconfigured by the network. The conditions can be dynamically updated by the UE as well. If step 401 determines yes, the UE moves step 403 and starts the access to the target small cell. If step 401 determines no, the UE moves step 402 and continues with collecting and analyzing the UE status information.

FIG. 4B illustrates an exemplary flow chart where the UE determines that the criteria are met if enough high priority conditions are met in accordance with embodiments of the current invention. The UE prioritize the conditions based on at least one of the diverse traffic type, deployment scenarios, and other related situations. In one embodiment, the UE status information is prioritized in different orders based on different situations. In another embodiment, different weight applies to different UE status information. The UE determines whether one or more the criteria are met based on the weighted UE status information. At step 411, the UE determines whether enough high priority conditions are met. If step 411 determines yes, the UE moves to step 413 and starts the access to the target small cell. If step 411 determines no, the UE moves to step 412 and continues with collecting and analyzing the UE status information.

FIG. 5A illustrates an exemplary flow chart where the UE determines that the criteria are met if all conditions are met with examples in accordance with embodiments of the current invention. At step 501, the UE determines whether the amount of traffic volume is greater than a threshold. If step 501 determines no, the UE moves to step 504 and continues with collecting and analyzing the UE status information. If step 501 determines yes, the UE moves to step 502 and determines if the low mobility status is met. If step 501 determines no, the UE moves to step 504 and continues with collecting and analyzing the UE status information. If step 502 determines yes, the UE moves to step 503 and determines if there are one or more small cells available in the proximity. If step 503 determines no, the UE moves to step 504 and continues with collecting and analyzing the UE status information. If step 503 determines yes, the UE moves to step 505, optionally and initiates the measurement procedure. The UE then moves to step 506 and initiates access to the small cell.

FIG. 5B illustrates an exemplary flow chart where the UE determines the criteria are met if enough high priority conditions are met with examples in accordance with embodiments of the current invention. At step 511, the UE determines whether the traffic volume is greater than a threshold. If step 511 determines yes, the UE moves to step 521 and determines whether enough conditions are met. If step 521 determines yes, the UE moves to step 531, optionally, and initiates the measurement procedure. The UE then moves to step 532 and initiates access to the small cell. If steps 521 determines no or step 511 determines no, the UE moves to step 512 and determines if the low mobility status is met. If step 512 determines yes, the UE moves to step 522 and determines whether there are enough conditions met. If step 522 determines yes, the UE moves to step 531, optionally, and initiates the measurement procedure. The UE then moves to step 532 and initiates access to the small cell. If steps 522 determines no or step 512 determines no, the UE moves to step 513 and determines if there are one or more small cell available in the proximity. If step 513 determines yes, the UE moves to step 523 and determines whether there are enough conditions met. If step 523 determines yes, the UE moves to step 531, optionally, and initiates the measurement procedure. The UE then moves to step 532 and initiates access to the small cell. If step 523 determines no or step 513 determines no, the UE moves to step 533 and continues with collecting and analyzing the UE status information.

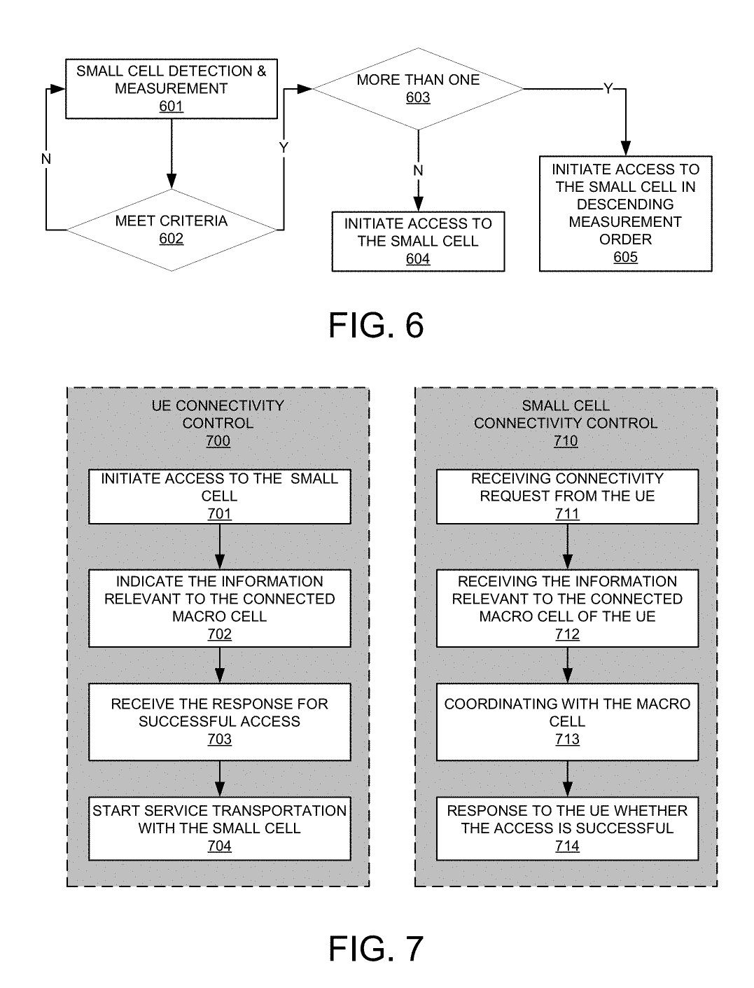

FIG. 6 illustrates an exemplary flow chart of connectivity initiation procedure by the UE in accordance with embodiments of the current invention. At step 601, the UE starts the small cell, such an mmW small cell, detection and measurement. At step 602, the UE determines if the predefined criteria are met. If step 602 determines no, the UE moves back to step 601. If step 602 determines yes, the UE moves to step 603 and determines if more than one small cell are suitable for access, such as the channel quality of those cells is above a threshold. If step 603 determines no, the UE moves to step 604 and autonomously initiates access to the small cell. If step 603 determines yes, the UE moves to step 605 and autonomously initiates access to the small cells in descending measurement order.

FIG. 7 illustrates exemplary flow charts of connectivity control for the UE and the small-cell base station in accordance with embodiments of the current invention. FIG. 7 includes a flow chart 700 for the UE connectivity control. At step 701, the UE initiates access to the small cell, such as an mmW small cell. At step 702, the UE indicates the information relevant to the connected macro cell. At step 703, the UE receives the response for the successful access. At step 704, the UE starts service transportation with the small cell, such as an mmW small cell. FIG. 7 also includes a flow chart 710 for the small cell, such as the mmW small cell, connectivity control. At step 711, the small cell receives connectivity request from the UE. At step 712, the small cell receives information relevant to the connected macro cell of the UE. At step 713, the small cell coordinates with the macro cell. At step 714, the small cell responds to the UE about whether the access is successful.

In one novel aspect, the UE-centric measurement and connectivity control procedures are implemented to reduce latency and improve system performance. In one embodiment, the UE informs the small cell to which macro cell the RRC connection is maintained. The small cell subsequently finds the macro cell and establishes the X2 interface for the UE. In another embodiment, if the UE cannot acquire a good quality small cell, the UE transmits/receives service through the macro cell. If the small cell of good quality can be acquired immediately, the UE starts transmitting and receiving through the small cell. In yet another embodiment, the UE starts a timer to supervise the connectivity establishment procedure with the small cells. Upon expiration of the supervise timer, the UE either stops the small cell search and measurement or the UE switches from an intensive small cell search and measurement to a sparse cell search and measurement.

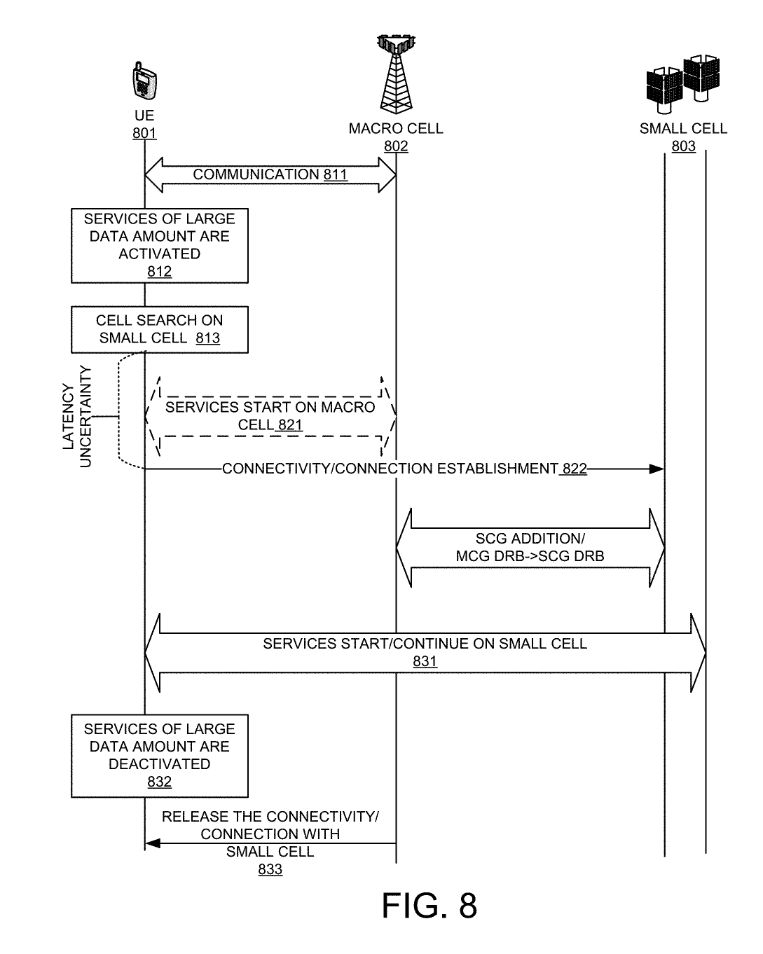

FIG. 8 illustrates an exemplary diagram of the autonomous UE-centric measurement and connectivity control procedures in accordance with embodiments of the current invention. A UE 801 is connected with a macro cell 802, which overlaps with one or more small cells 803. In one embodiment, the small cell is the mmW small cell. At step 811, the UE establishes connection and communicates with macro cell 802. At step 812, the UE detects service of large data amount being activated. In one embodiment, the activation of large data amount triggers the UE-centric autonomous connectivity control. At step 813, the UE starts cell search on small cells. Optionally, the UE starts service with the macro cell 802 at step 821. At step 822, the UE autonomously initiates access to small cells and establishes connection with the small cell. Upon successful reception of the information relevant to the macro cell from the UE, small cell 803 exchanges information with macro cell 802 through the X2 interface with secondary cell group (SCG) addition message and master cell group (MCG) data radio bearer (DRB) to SCG DRB message. At step 831, services start/continue on the small cell after reception of the response for successful access. At step 832, the UE detects that services of large data amount are deactivated. At step 833, the UE receives release the connectivity connection with small cell from macro cell 802.

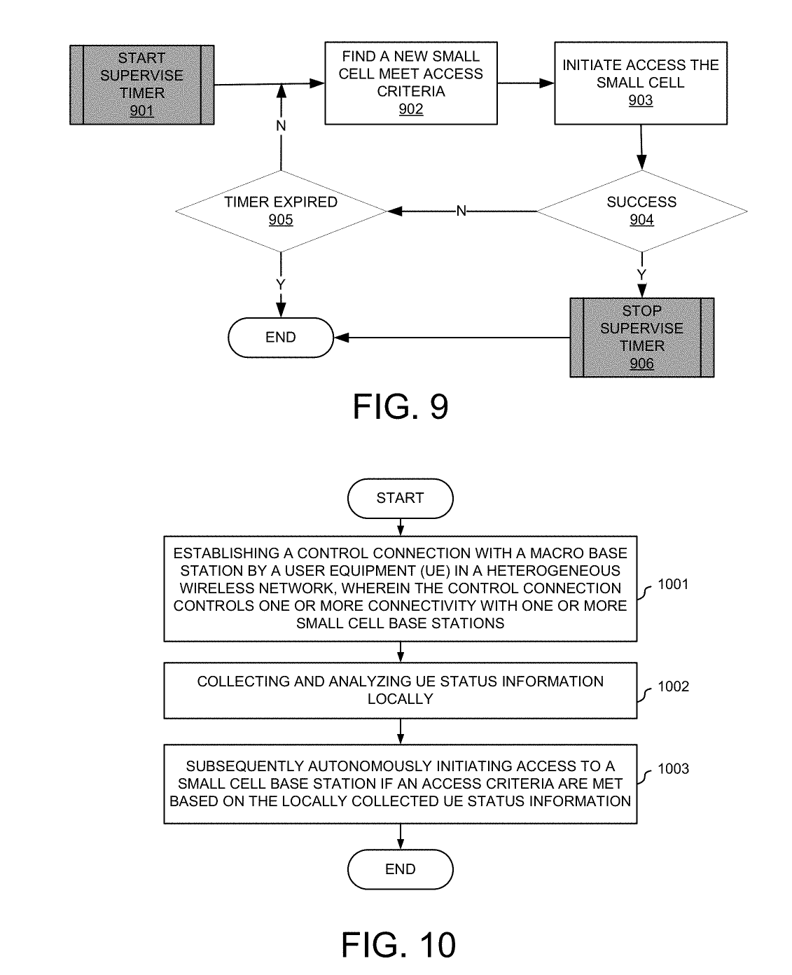

FIG. 9 illustrates an exemplary flow chart of using a supervise timer for the autonomous UE-centric connectivity control procedure in accordance with embodiments of the current invention. At step 901, the UE starts the supervise timer. The timer is used to supervise the access procedure to the small cells, and optionally, the measurement procedures. The timer is started upon initiation of the access procedure to the small cells, or optionally upon initiation of the measurement procedure. At step 902, the UE finds a new small cell that meets the access criteria. At step 903, the UE initiates access to the small cell. At step 904, the UE determines if the access is successful. If step 904 determines yes, the UE moves to step 906, stops the supervise timer, and terminates the procedure. If step 904 determines no, the UE moves to step 905 and checks if the supervise timer expires. If step 905 determines no, the UE moves back to step 902 to find the next available small cell. If step 905 determines yes, the UE terminates the procedure.

FIG. 10 illustrates an exemplary flow chart of the UE autonomous measurement and connectivity control procedures in the heterogeneous network in accordance with embodiments of the current invention. At step 1001, the UE establishes a connection with a macro base station in a heterogeneous wireless network. At step 1002, the UE collects and analyzes UE status information locally. Subsequently, at step 1003, the UE autonomously initiates access to a small cell base station if access criteria are met based on the locally collected UE status information.

In the above embodiments, the UE could use reverse discovery procedure, if the MMW small cell of good quality can be acquired before the expiry of the timer, UE will begin the transmission/reception for the service through the MMW small cell. Or if the timer expires and no MMW small cell of good quality is acquired, UE falls back to the macro cell and begins the transmission/reception for the service through the Macro cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing a control connection with a macro base station by a user equipment (UE) in a heterogeneous wireless network;
collecting and analyzing UE status information locally; and
subsequently, autonomously initiating access to a small cell base station if one or more access criteria are met based on the locally collected UE status information.

2. The method of claim 1, wherein the one or more small cell base stations are millimeter wave (mmW) base stations.

3. The method of claim 1, wherein the UE status information comprises: traffic quality of service (QoS) requirements, UE mobility status, and position information.

4. The method of claim 1, wherein the access criteria are based on triggering conditions comprising one or more of the following ones: a required data traffic rate is higher than a data-traffic rate threshold, an amount of traffic volume is higher than a traffic volume threshold, a UE mobility speed is lower than a speed threshold, and the UE is in a proximity of one or more small cell cells.

5. The method of claim 4, wherein the access criteria are detecting all the triggering conditions.

6. The method of claim 4, wherein the triggering conditions are prioritized, and wherein the access criteria are met when one or more high priority triggering conditions are met.

7. The method of claim 6, wherein traffic QoS requirements have the highest priority.

8. The method of claim 4, wherein the locally available UE information comprises one or more of the following ones: a footprint of the UE, and historical geographic information.

9. The method of 1, further comprising:
informing the one or more small cell base stations about the information relevant to the macro base station; and
receiving acknowledgement for service transportation from the one or more small cell base stations.

10. The method of claim 1, further comprising:
starting a supervising timer upon initiating accessing the one or more small cell base stations;
autonomously initiating a subsequent accessing procedure to another small cell base station upon detecting an access failure until the supervising timer expires; and
stopping the supervising timer if access to one of the small cells succeed

11. The method of claim 10, wherein the supervising time is started upon initiating measurement on the one or more small cells.

12. A user equipment (UE), comprising:
a transceiver that transmits and receives radio signals via a plurality of radio access links;
a connection manager that establishes a connection with a macro base station in a heterogeneous wireless network;
a status collector that collects and analyzes UE status information locally; and
a connectivity manager that autonomously initiates access to a small cell base station after the establishment of the connection if access criteria are met based on the locally collected UE status information.

13. The UE of claim 12, wherein the one or more small cell base stations are millimeter wave (mmW) base stations.

14. The UE of claim 12, wherein the UE status information comprises: traffic quality of service (QoS) requirements, UE mobility status, and position information.

15. The UE of claim 12, wherein the access criteria are based on triggering conditions comprise: a required data traffic rate is higher than a data-traffic rate threshold, an amount of traffic volume is higher than a traffic volume threshold, a UE mobility speed is higher than a speed threshold, and the UE is in a proximity of one or more small cell cells.

16. The UE of claim 15, wherein the access criteria are detecting all the triggering conditions.

17. The UE of claim 15, wherein the triggering conditions are prioritized, and wherein the access criteria are met when one or more high priority triggering conditions are met.

18. The UE of claim 17, wherein traffic QoS requirements have the highest priority.

19. The UE of claim 15, wherein the locally available UE information comprising one or more of the following ones: a footprint of the UE, and historical geographic information.

20. The UE of 12, further comprising:
a message handler that informs the one or more small cell base stations about the information relevant to the macro base station, and receives acknowledgement for service transportation from the one or more small cell base stations.

21. The UE of claim 12, further comprising:
a timer handler that starts a supervising timer before initiating accessing the one or more small cell base stations, stops a timer when access to one small cell succeed and reports a timeout upon expiration of the supervising timer, and wherein the connectivity manager autonomously initiates a subsequent accessing procedure to another small cell base station upon detecting an access failure until the supervising timer expires.

22. The UE of claim 21, wherein the supervising timer is started upon initiating the measurement procedure on the one or more small cells.
